(19) United States
(12) Patent Application Publication
(10) Pub. No.: US 2020/0190677 A1
(43) Pub. Date: Jun. 18, 2020

(54) CATALYST INCLUDING SULFATED TRANSITION METAL OXIDES AND USED FOR ELECTRO-FENTON SYSTEM, ELECTRODE INCLUDING THE CATALYST, AND ELECTRO-FENTON SYSTEM USING THE ELECTRODE

(71) Applicant: KOREA INSTITUTE OF SCIENCE AND TECHNOLOGY, Seoul (KR)

(72) Inventors: Jongsik KIM, Seoul (KR); Sang Hoon KIM, Seoul (KR); Heon Phil HA, Seoul (KR)

(73) Assignee: KOREA INSTITUTE OF SCIENCE AND TECHNOLOGY, Seoul (KR)

(21) Appl. No.: 16/432,612

(22) Filed: Jun. 5, 2019

(30) Foreign Application Priority Data
Dec. 14, 2018 (KR) 10-2018-0161667

(51) Int. Cl. C25B 11/04; C25B 1/30; C02F 1/461

(52) U.S. Cl. CPC C25B 11/0452; C02F 2001/46142; C02F 1/46109; C25B 1/30

(57) ABSTRACT

Provided is a catalyst for an electro-Fenton system. The catalyst includes one or more species of SO₄²⁻-functionalized transition metal oxide grains. Also provided is an electrode for an electro-Fenton system. The electrode includes the catalyst. Also provided is an electro-Fenton system that includes the catalyst, an electrode comprising the catalyst, and an aqueous electrolyte solution.

### CROSS-REFERENCE TO RELATED PATENT APPLICATION

This application claims the benefit of Korean Patent Application No. 10-2018-0161667, filed on Dec. 14, 2018, in the Korean Intellectual Property Office, the disclosure of which is incorporated herein in its entirety by reference.

### BACKGROUND

### 1. Field

The present invention relates to a catalyst used for an electro-Fenton system to efficiently decompose a non-biodegradable organic material, an electrode including the catalyst, and an electro-Fenton system using the electrode. More particularly, the present invention relates to a catalyst for an electro-Fenton system, by which 1) SO₄²⁻-functionalized transition metal oxide catalysts are converted into a SO_{4.}⁻-functionalized transition metal oxide catalyst by .OH species formed during operation of an electro-Fenton system, and 2) SO_{4.}⁻-functional groups on the catalyst surface decompose a non-biodegradable organic material based on heterogeneous catalysis, an electrode including the catalyst, and an electro-Fenton system using the electrode.

### 2. Description of the Related Art

One of currently attractive wastewater treatment technologies is an advanced oxidation process (AOP) for oxidizing and decomposing non-biodegradable or toxic organic materials included in water by sufficiently forming a highly active radical (e.g., .OH or SO_{4.}⁻) oxidizer in wastewater. As a representative AOP process, a single catalyst process commercialized in a small scale for sewage/wastewater treatment plants is an electro-Fenton process for oxidizing and decomposing non-biodegradable organic materials by applying a voltage between an anode not coated with a catalyst and a cathode coated with a catalyst, and has three major advantages as described below. 1) An unlimited quantity of H₂O₂ may be supplied due to O₂ reduction occurring on the cathode (2H⁺+O₂+2e⁻→H₂O₂), 2) a considerable quantity of .OH may be supplied due to H₂O oxidation (H₂O→.OH+H⁺+e⁻) on the anode or heterogeneous or homogeneous catalytic decomposition of H₂O₂ (catalytic H₂O₂ scission: H₂O₂→.OH+OH⁻) by metal species M^{δ+} (M: metal; δ≤2) on the surface of the catalyst coated on the cathode, and 3) metal species M^{(δ+1)+} formed as a result of the catalytic decomposition of H₂O₂ may be reduced to the metal species M^{δ+} by sufficient electrons e⁻ in a reaction solution and be reused for catalytic decomposition of H₂O₂.

### SUMMARY

In spite of the above-described advantages of the electro-Fenton process, the following various disadvantages thereof restrict commercialization of the electro-Fenton process in a large scale for wastewater treatment.

First, a limited quantity of the metal species M^{δ+} on the surface of the catalyst coated on the cathode ultimately form a limited quantity of .OH in spite of continuous recovery to the metal species M^{δ+} from the metal species M(^{δ+1)+} formed as a result of catalytic decomposition of H₂O₂, and thus a non-biodegradable organic material decomposition rate by .OH is reduced.

Second, the electro-Fenton process performed under relatively harsh conditions causes continuous and serious leaching of the metal species M^{δ+} on the surface of the catalyst coated on an electrode, and thus the number of uses of the coated catalyst is restricted and the performance of organic material decomposition is reduced.

Third, .OH used in this process reduces the efficiency of organic material decomposition due to a short lifespan thereof, and requires a limited range of pH for efficient production of .OH.

The present invention is aimed to decompose a non-biodegradable organic material based on heterogeneous catalysis by coating SO₄²⁻-functionalized transition metal oxide catalysts on an electrode.

The present invention is also aimed to provide a new radical formation path by which continuous OH formation is induced and formed .OH changes SO₄²⁻ species on the surface of a metal oxide catalyst, into SO_{4.}⁻-species through radical interconversion

The present invention is also aimed to reduce leaching of grains during non-biodegradable organic material decomposition by using the catalyst, to maintain a non-biodegradable organic material decomposition rate during multiple uses of the catalyst, and thus to increase the performance and a lifespan of a reaction system.

However, the scope of the present invention is not limited thereto.

According to an aspect of the present invention, there is provided a catalyst for an electro-Fenton system, the catalyst including one or more species of SO₄²⁻-functionalized transition metal oxide grains.

The transition metal oxide grains may have a porous structure.

The transition metal oxide grains may have a diameter of 0.1 nm to 500 μm.

A transition metal of the transition metal oxide grains may include at least one or a combination of two or more selected from the group consisting of scandium (Sc), titanium (Ti), vanadium (V), chromium (Cr), manganese (Mn), iron (Fe), zinc (Zn), copper (Cu), nickel (Ni), cobalt (Co), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), and gold (Au).

.OH species may be formed due to heterogeneous catalysis of the transition metal oxide grains. The ▪OH species may convert SO₄²⁻ species functionalized on surfaces of the transition metal oxide grains, into SO_{4.}⁻ species, and a non-biodegradable organic material may be decomposed by the SO_{4.}⁻ species.

According to another aspect of the present invention, there is provided a method of manufacturing a catalyst for an electro-Fenton system, the method including preparing transition metal oxide, and functionalizing a surface of the transition metal oxide to SO₄²⁻ by sulfating the transition metal oxide.

The sulfation may be performed by a reaction gas including SO₂ and O₂. A concentration of each of SO₂ and O₂ in the reaction gas may range from 10 ppm to 10⁵ ppm.

The reaction gas may have a flow rate of 10⁻⁵ mL min⁻¹ to 10⁵ mL min⁻¹, and have a pressure of 10⁻⁵ bar to 10⁵ bar.

The sulfation may be performed in a temperature range from 200° C. to 700° C., and more specifically, in a temperature range from 300° C. to 600° C.

According to another aspect of the present invention, there is provided an electrode for an electro-Fenton system, the electrode including the above-described catalyst.

The electrode may further include a conductive substrate, a catalyst layer coated on at least one surface of the conductive substrate and including the catalyst, and a binder layer provided between the conductive substrate and the catalyst layer.

The catalyst layer may include a carrier supporting the catalyst. The carrier may include carbon (C), Al₂O₃, MgO, ZrO₂, CeO₂, TiO₂, or SiO₂. The catalyst may be included by 0.01 weight part to 50 weight parts based on 100 weight parts of the carrier.

A binder of the binder layer may include insoluble polymer. According to another aspect of the present invention, there is provided an electro-Fenton system including the above-described catalyst, an electrode including the catalyst, and an aqueous electrolyte solution.

The aqueous electrolyte solution may have a pH ranging from 5 to 10.

### BRIEF DESCRIPTION OF THE DRAWINGS

The above and other features and advantages of the present invention will become more apparent by describing in detail embodiments thereof with reference to the attached drawings in which:

FIG. 1 includes scanning electron microscopic (SEM) images of iron oxide grains and SO₄²⁻-functionalized iron oxide grains according to Embodiments 1 to 5 of the present invention;

FIG. 2 includes SEM images of SO₄²⁻-functionalized metal (manganese, cobalt, nickel, and copper) oxide grains according to Embodiments 6 to 9 of the present invention;

FIG. 3 is a schematic diagram of an electro-Fenton system including a catalyst layer, according to an embodiment of the present invention;

FIG. 4 is a graph showing X-ray diffraction (XRD) patterns of iron oxide grains and

SO₄²⁻-functionalized iron oxide grains according to Embodiments 1 to 5 of the present invention;

FIG. 5 is a graph showing XRD patterns of SO₄²⁻-functionalized metal (manganese, cobalt, nickel, and copper) oxide grains according to Embodiments 6 to 9 of the present invention;

FIG. 6A is a graph showing X-ray photoelectron (XP) spectroscopy results in a Fe2p region of iron oxide grains and SO₄²⁻-functionalized iron oxide grains according to Embodiments 1 to 5 of the present invention;

FIG. 6B is a graph showing background-subtracted, in situ diffuse reflectance infrared Fourier transform (DRIFT) spectroscopy results of catalyst surfaces saturated with NH₃ at 50° C. of iron oxide grains and SO₄²⁻-functionalized iron oxide grains according to Embodiments 1 to 5 of the present invention

FIG. 6C is a graph showing XP spectroscopy results in a S2p region of iron oxide grains and SO₄²⁻-functionalized iron oxide grains according to Embodiments 1 to 5 of the present invention

FIG. 7 is a graph showing results of electro-Fenton tests (Test Example 1, Test Example 2, and Test Example 3) using catalysts synthesized according to Embodiments 1 to 5 of the present invention;

FIG. 8 is a graph showing decomposition quantities of phenol based on time (Test Example 4) using catalysts synthesized according to Embodiments 1 to 5 of the present invention;

FIG. 9 is a graph showing results of an electro-Fenton recycle test (Test Example 5) using catalysts synthesized according to Embodiments 3 and 4 of the present invention; and

FIG. 10 is a graph showing results of an electro-Fenton test (Test Example 7) using catalysts synthesized according to Embodiments 6 to 9 of the present invention.

### DETAILED DESCRIPTION

The following detailed descriptions of the invention will be made with reference to the accompanying drawings illustrating specific embodiments of the invention by way of example. These embodiments will be described in detail such that the invention can be carried out by one of ordinary skill in the art. It should be understood that various embodiments of the invention are different, but are not necessarily mutually exclusive. For example, a specific shape, structure, and characteristic of an embodiment described herein may be implemented in another embodiment without departing from the scope of the invention. In addition, it should be understood that a position or placement of each component in each disclosed embodiment may be changed without departing from the scope of the invention. Accordingly, there is no intent to limit the invention to the following detailed descriptions. The scope of the invention is defined by the appended claims and encompasses all equivalents that fall within the scope of the appended claims. In the drawings, like reference numerals denote like functions, and the dimensions such as lengths, areas, and thicknesses of elements may be exaggerated for clarity.

Hereinafter, to allow one of ordinary skill in the art to easily carry out the invention, embodiments of the present invention will be described in detail with reference to the accompanying drawings.

Transition metal oxide and SO₄²⁻-functionalized transition metal oxide grains According to an embodiment of the present invention, a catalyst for an electro-Fenton system may include one or more species of SO₄²⁻-functionalized transition metal oxide grains.

Specifically, the transition metal oxide grains of the present invention may have an oxidation number of metal species M varying between 1 and 4 and include all metal oxide crystal structures which are in a stabilized form on a metal-oxygen phase diagram.

For example, the transition metal oxide grains may include Mn₂O₃, Mn₃O₄, Co₃O₄, Fe₂O₃, NiO, CuO, or Cu₂O.

A transition metal included in the transition metal oxide grains may be a transition metal of period 4 to period 6. According to an embodiment of the present invention, the transition metal may include at least one selected from the group consisting of scandium (Sc), titanium (Ti), vanadium (V), chromium (Cr), manganese (Mn), iron (Fe), zinc (Zn), copper (Cu), nickel (Ni), cobalt (Co), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), and gold (Au), or a combination thereof.

The catalyst for the electro-Fenton system may be synthesized using a method generally usable to form specific transition metal oxide grains. For example, the transition metal oxide grains included in the catalyst may be synthesized using one or more methods among hydrothermal synthesis, solvothermal synthesis, a mechano-chemical method (ball-milling), a non-templated or templated method, impregnation method, dip coating, and a calcination or thermal decomposition method using M-including complex.

The electro-Fenton system may form SO_{4.}⁻-surface species by using OH species formed as a result of oxidation of water (H₂O→.OH+H⁺+e⁻) on an anode, as active sites of SO₄²⁻ functional groups in the transition metal oxide grains coated on a cathode. Therefore, to promote the oxidation of water, various types of conductive materials may be used as the anode and, more specifically, graphite may be used.

The electro-Fenton system catalyst may include metal species M^{δ+} used to decompose H₂O₂ formed as a result of reduction of oxygen (2H⁺+O₂+2e⁻→H₂O₂) on the cathode, on the catalyst surface. Herein, δ may have a different value depending on the type of metal. For example, δ may have a value less than 3 for iron (Fe), cobalt (Co), nickel (Ni), and copper (Cu), and have a value less than 4 for manganese (Mn).

Specifically, catalytic decomposition of H₂O₂ (H₂O₂→.OH+OH⁻) may be activated based on catalysis using the metal species M^{δ+}, and the SO₄²⁻ functional groups on the transition metal oxide grains coated on the cathode may be converted into the SO_{4.}⁻ surface species by using .OH species formed as a result of reaction.

Therefore, a large quantity of the metal species M^{δ+} needs to be included to promote the catalytic decomposition of H₂O₂, and easily-synthesizable and low-priced transition metal oxide may be used as a catalyst for coating the cathode.

The electro-Fenton system catalyst may form the SO_{4.}⁻surface species based on radical conversion from the SO₄²⁻ functional groups due to the .OH species, and thus may promote decomposition of non-biodegradable organic materials. Therefore, a large quantity of the SO₄²⁻ functional groups may be contained on the surface of the transition metal oxide catalyst.

According to an embodiment of the present invention, sulfation may be performed by a reaction gas including SO₂ and O₂. The reaction gas may have a concentration of SO₂ and O₂ ranging from 10 ppm to 10⁵ ppm, a flow rate ranging from 10⁻⁵ mL min⁻¹ to 10⁵ mL min⁻¹, and a pressure ranging from 10⁻⁵ bar to 10⁵ bar. The sulfation may be performed in a temperature range from 200° C. to 700° C., and more specifically, in a temperature range from 300° C. to 600° C. A process time of the sulfation may range from 0.1 hour to 24 hours.

When conditions for sulfating the catalyst do not reach the above-mentioned ranges, the SO₄²⁻ functionalization effect of the transition metal oxide catalyst may be insufficient. When the conditions exceed the above-mentioned ranges, the surface of the transition metal oxide may be excessively functionalized and thus metal species M^{δ+} which promote catalytic decomposition activity of H₂O₂ may vanish. Therefore, the sulfation of the catalyst may be performed within the above-mentioned ranges of the conditions.

A rate at which .OH species are formed by the metal species M^{δ+} and a rate at which SO₄²⁻functional groups on the catalyst surface are converted into SO_{4.}⁻ surface species by the .OH species may be increased in proportion to a surface area of the catalyst for the electro-Fenton system according to the present invention (Reaction Formulas (1) and (2)).

Since the SO₄ surface species in the reaction system are increased in proportion to the rate at which the .OH species are formed and the rate at which the SO₄²⁻ functional groups are converted, decomposition of a harmful material may be ultimately promoted.

Reaction Formula (1): SO₄²⁻+.OH+H⁺→SO₄⁻+H₂O

Reaction Formula (2): SO₄²⁻+.OH+→SO₄⁻+OH⁻

According to an embodiment of the present invention, the SO₄²⁻-functionalized transition metal oxide grains may have a porous structure and iron sulfide grains may have a diameter of 0.1 nm to 500 μm.

When the transition metal oxide grains have a small diameter and have a rough surface with pores or protrusions, a surface area thereof is increased and thus a catalytic decomposition rate of H₂O₂ is increased. As such, the rate at which the .OH species are formed and the rate at which the SO₄²⁻functional groups on the catalyst surface are converted into the SO₄⁻-surface species by the .OH species may be increased.

In addition, when the transition metal oxide grains have the above two morphological features, they may be coated on the cathode at a higher intensity. This means that a vortex of an aqueous electrolyte solution for electro-Fenton reaction and leaching of the catalyst due to external electricity are reduced and thus a lifespan of an electrode is increased.

When the catalyst is leached from the electrode, .OH formation or non-biodegradable organic material decomposition by SO_{4.}⁻ may be performed based on homogeneous catalysis by the leached catalyst species. In this case, the efficiency of non-biodegradable organic material decomposition is reduced and the number of times that the electro-Fenton catalyst is used is limited.

That is, when the leaching phenomenon is reduced, since .OH formation or non-biodegradable organic material decomposition by SO_{4.}⁻ occurs due to heterogeneous catalysis by the transition metal oxide grains coated on the cathode, the performance of the electro-Fenton catalyst may be maintained even after multiple uses.

Therefore, the transition metal oxide grains of the present invention may have porous and rough surface characteristics to suppress leaching from the electrode.

Electrode and electro-Fenton system including SO₄²⁻-functionalized transition metal oxide catalyst

An electrode including a catalyst for an electro-Fenton system, and an electro-Fenton system using the same will now be described.

The electrode includes a conductive substrate, and a catalyst layer coated on at least one surface of the conductive substrate and including a catalyst for an electro-Fenton system. A binder layer for increasing an adhesive strength between the catalyst layer and the conductive substrate is provided between the conductive substrate and the catalyst layer.

The substrate may include a conductive material generally used for electrochemical reaction. For example, graphite or metal such as copper or aluminum may be used.

The catalyst for the electro-Fenton system includes SO₄²⁻-functionalized transition metal oxide grains as described above. For the catalyst layer, the catalyst may be directly coated on one or both surfaces of the substrate by a binder.

As another example, to more stably and efficiently configure the electrode, the catalyst layer may include a carrier supporting the catalyst. In this case, the carrier may be coated on at least one surface of the substrate and, more specifically, both surfaces of the substrate.

According to an embodiment of the present invention, the carrier may be carbon (C), Al₂O₃, MgO, ZrO₂, CeO₂, TiO₂, or SiO₂, and the catalyst for the electro-Fenton system may be included by 0.01 weight part to 50 weight parts based on 100 weight parts of the carrier.

The carrier supporting the catalyst may be coated on the substrate by using an impregnation method. In this case, the content of the coated catalyst may be adjusted to increase the efficiency of .OH formation or non-biodegradable organic material decomposition by SO₄ and to enable appropriate migration of .OH to SO₄²-functional groups on the catalyst surface.

When the catalyst layer is coated on the substrate, a binder may be used to increase the adhesive strength between the catalyst and the substrate. Therefore, an adhesive layer including the binder is provided between the substrate and the catalyst layer. In this case, the binder may be an insoluble polymer and, more specifically, polyvinylidene fluoride (PVDF).

The binder is capable of increasing a coating adhesive strength between the catalyst layer and the substrate. When the binder has insoluble properties, since the binder is not dissolved in an aqueous solution even after an electro-Fenton process is repeatedly performed, leaching of the catalyst may be prevented. That is, a lifespan of the electrode for the electro-Fenton system may be increased by suppressing leaching of the catalyst.

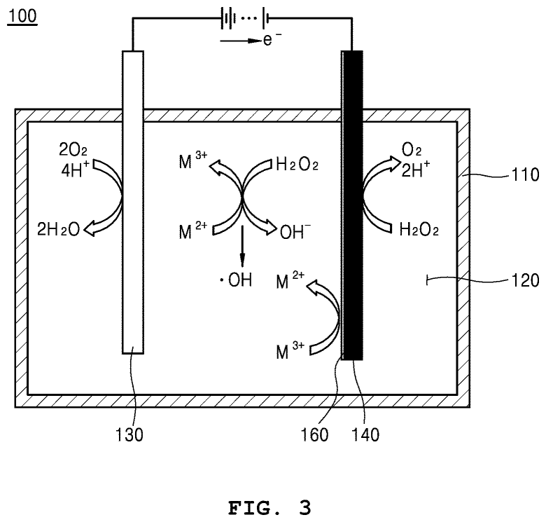

FIG. 3 is a schematic diagram of an electro-Fenton system 100 including a catalyst layer 160, according to an embodiment of the present invention.

The electro-Fenton system 100 may include the catalyst layer 160, an anode 130 not coated with the catalyst layer 160, a cathode 140 coated with the catalyst layer 160, and an aqueous electrolyte solution 120.

The anode 130 may be connected to the cathode 140 by a power source, and the anode 130 and the cathode 140 may include a conductive material. In this case, the conductive material may be graphite. At least one surface of the cathode 140 may be coated with the catalyst layer 160, and the catalyst layer 160 may include a catalyst including the above-described SO₄²⁻-functionalized iron oxide grains according to an embodiment of the present invention.

Sufficient .OH species are formed due to H₂O oxidation by using the anode 130 not coated with the catalyst layer 160 including the transition metal oxide grains proposed by the present invention. By using the cathode 140 coated with the catalyst layer 160 including the transition metal oxide grains proposed by the present invention, instantaneous catalytic decomposition of H₂O₂ by metal species M^{δ+} included in the surface of the transition metal oxide catalyst is implemented. As such, a rate at which .OH species are formed due to catalytic decomposition of H₂O₂ based on heterogeneous catalysis in a specific reaction condition is additionally increased.

In this case, when the rate at which the .OH species are formed due to oxidation of H₂O and catalytic decomposition of H₂O₂ is increased, a speed at which the .OH species move to SO₄²⁻ functional groups on the surface of the catalyst layer 160 coated on the cathode 140 is increased and a rate at which SO₄⁻ species are formed on the catalyst surface due to radical conversion between .OH and SO₄²⁻ is increased. That is, highly-efficient decomposition of an organic material by the SO_{4.}⁻ species based on heterogeneous catalysis is enabled.

The aqueous electrolyte solution 120 is an aqueous solution used for electro-Fenton reaction and may selectively use one or a combination of Na₂SO₄, NaNO₃, NH₄F, KF, KCl, KBr, KI, NaF, NaCl, NaBr, and NaI having a concentration of 10⁻⁴ mol/L to 10 mol/L.

A procedure of decomposing an organic material based on catalysis occurring in the electro-Fenton system 100. Reactions occurring in the electro-Fenton system 100 are expressed by Reaction Formulas (3) to (10).

Reaction Formula (3):

2H₂O ->O₂+4H⁺+4e⁻

Reaction Formula (4):

O₂+2H⁺+2e⁻->H₂O₂

Reaction Formula (5):

M^{(δ+1)+}+e⁻->M^{δ+}

Reaction Formula (6):

M^{δ+}+H₂O₂->M^{(δ+1)+}+OH⁻+−.OH

Reaction Formula (7):

H₂O→.OH+H⁺+e⁻

Reaction Formula (8):

SO₄²⁻+.OH+H⁺→SO_{4.}⁻+H₂O

Reaction Formula (9):

SO₄²⁻+.OH→SO_{4.}⁻+OH⁻

Reaction Formula (10): SO_{4.}⁻+e⁻SO₄²⁻

Initially, water is decomposed into oxygen (O₂) and hydrogen ions (H⁺) on the anode 130 due to oxidation by an external power source. O₂ and H⁺ formed in this case are reduced on the cathode 140 to form hydrogen peroxide (H₂O₂). The formed hydrogen peroxide reacts with the metal species M^{δ+} included in the transition metal oxide grains to form .OH and metal species M(^{δ+1)+} of an oxidation number δ+1, and the metal species M^{(δ+1)+} of the oxidation number δ+1 are reduced by electrons e⁻to be recovered to the metal species M^{δ+}.

As such, a conventional problem that metal species M^{(δ+1)+} of an oxidation number δ+1 formed due to reaction between metal species M^{δ+} and H₂O₂ are not recovered to the metal species M^{δ+} may be solved, and H₂O₂ may be continuously supplied by supplying O₂ due to electrolysis of water.

In addition, .OH may also be continuously supplied due to oxidation of H₂O on the anode 130. That is, H₂O oxidation occurring on the anode 130 and catalytic decomposition of H₂O₂ occurring on the cathode 140 increase a yield of .OH, and formed .OH interacts with the SO₄²⁻ functional groups on the surface of the catalyst layer 160 coated on the cathode 140, to form SO_{4.}⁻ surface species.

In this case, a yield of the SO_{4.}⁻ surface species is increased in proportion to the SO₄²⁻ functional groups on the surface of the coated catalyst layer 160 and thus the performance of organic material decomposition by SO₄⁻ may be increased. SO_{4.}⁻ not used for organic material decomposition may be reduced by electrons e⁻ to be recovered to the SO₄²⁻ functional groups, and may be subsequently used to form the SO_{4.}⁻-surface species.

In addition, SO₄ formed due to the above-described reaction may decompose a non-biodegradable or toxic organic material. The organic material may include toxic, carcinogenic, and mutagenic materials based on phenol. Specifically, the organic material may be a material having a structure, in which at least one of carbons of a monocyclic or polycyclic aromatic material is substituted with oxygen (O), nitrogen (N), or sulfur (S), as a backbone, and including various functional groups of alkane, alkene, alkyne, amine, amide, nitro, alcohol, ether, halide, thiol, aldehyde, ketone, ester, carboxylic acid, etc. or derivatives thereof.

According to an embodiment of the present invention, the aqueous electrolyte solution 120 in which reaction of the catalyst occurs may have a pH of 5 to 10, and an electro-Fenton process may be performed at a power of 2 W or below. SO₄⁻ formation occurs on the surface of the catalyst coated on the cathode 140 in the aqueous electrolyte solution 120 for electro-Fenton reaction, and organic material decomposition is performed by SO_{4.}⁻. In this case, when the pH of the aqueous electrolyte solution 120 indicates an acidic level (pH<5) or an alkaline level (pH>10) or when the external power exceeds 2 W, the transition metal oxide grains or the SO₄²⁻ functional groups may be leached from the catalyst layer 160 coated on the cathode 140.

The leached homogeneous metal species M^{δ+} having an oxidation number equal to or less than 2, and the SO₄²⁻ functional groups may change the pH of the aqueous electrolyte solution 120, and may serve as a major activator of .OH and SO_{4.}⁻ formation. This leaching phenomenon reduces organic material decomposition efficiency and durability of the electro-Fenton system 100 when an electro-Fenton process is performed for a long time.

Therefore, for highly-efficient and continuous organic material decomposition, in the electro-Fenton system 100, the aqueous electrolyte solution 120 may have a pH of 5 to 10 and a power of 2 W or below may be input. More specifically, the aqueous electrolyte solution 120 may have a pH of 7 and a power of 0.04 W or below may be input.

Embodiments will now be described to promote understanding of the present invention. However, the following embodiments are merely to promote understanding of the present invention and embodiments of the present invention are not limited to the following embodiments.

### Embodiments

### Embodiment 1: Iron Oxide Catalyst

Porous and crystalline iron oxide (Fe₂O₃) was synthesized using a templated method. Specifically, 100 mL of an aqueous solution including 20 mmol of oxalic acid (C₂H₂O₄.2H₂O) and 20 mmol of FeSO₄.7H₂O was agitated for 30 minutes at 50° C. The mixture was filtered/washed using distilled water and ethanol, was dried at 70° C., and then was calcined at 300° C. for 1 hour, thereby synthesizing an iron oxide catalyst (Fe₂O₃). A pristine catalyst synthesized under the above-mentioned conditions is called Embodiment 1.

### Embodiment 2: Iron oxide catalyst functionalized with SO₄²⁻ at 300° C.

The pristine catalyst synthesized according to Embodiment 1 was exposed in an atmosphere of 500 ppm of SO₂diluted with N2/3 vol % O₂ at a flow rate of 500 mL min⁻¹ at 300° C. for 45 minutes, and then was cooled to room temperature in a N₂ atmosphere. A catalyst S300 synthesized under the above-mentioned conditions is called Embodiment 2.

### Embodiment 3: Iron oxide catalyst functionalized with SO₄²⁻ at 400° C.

A catalyst S400 which was synthesized under the same conditions as Embodiment 2 except that the temperature condition applied to Embodiment 2 was changed to 400° C. is called Embodiment 3.

### Embodiment 4: Iron oxide catalyst functionalized with SO₄²⁻ at 500° C.

A catalyst S500 which was synthesized under the same conditions as Embodiment 2 except that the temperature condition applied to Embodiment 2 was changed to 500° C. is called Embodiment 4.

### Embodiment 5: Iron oxide catalyst functionalized with SO₄²⁻ at 600° C.

A catalyst S600 which was synthesized under the same conditions as Embodiment 2 except that the temperature condition applied to Embodiment 2 was changed to 600° C. is called Embodiment 5.

### Embodiment 6: Manganese oxide catalyst functionalized with SO₄²⁻ at 500° C.

A Mn catalyst which was synthesized under the same conditions as Embodiment 1 except that the metal precursor applied to Embodiment 1 was changed to MnSO₄.H₂O, and then was functionalized with SO₄²⁻ under the same conditions as Embodiment 4 is called Embodiment 6.

### Embodiment 7: Cobalt oxide catalyst functionalized with SO₄²⁻ at 500° C.

A Co catalyst which was synthesized under the same conditions as Embodiment 1 except that the metal precursor applied to Embodiment 1 was changed to CoSO₄.7H₂O, and then was functionalized with SO₄²⁻ under the same conditions as Embodiment 4 is called Embodiment 7.

Embodiment 8: Nickel oxide catalyst functionalized with SO₄²⁻ at 500° C.

A Ni catalyst which was synthesized under the same conditions as Embodiment 1 except that the metal precursor applied to Embodiment 1 was changed to NiSO₄.7H₂O, and then was functionalized with SO₄²⁻ under the same conditions as Embodiment 4 is called Embodiment 8.

### Embodiment 9: Copper oxide catalyst functionalized with SO₄²⁻ at 500° C.

A Cu catalyst which was synthesized under the same conditions as Embodiment 1 except that the metal precursor applied to Embodiment 1 was changed to CuSO₄.5H₂O, and then was functionalized with SO₄²⁻ under the same conditions as Embodiment 4 is called Embodiment 9.

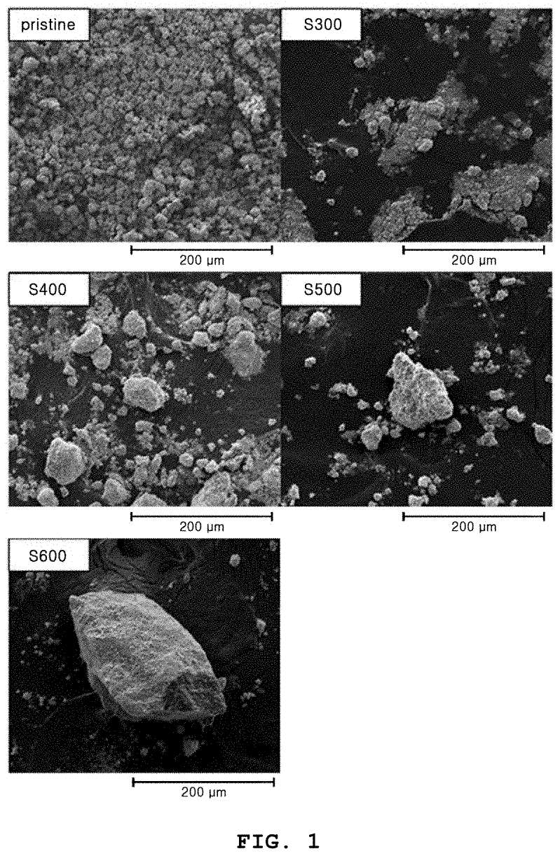

FIG. 1 includes scanning electron microscopic (SEM) images of iron oxide grains and SO₄²⁻-functionalized iron oxide grains according to Embodiments 1 to 5 of the present invention.

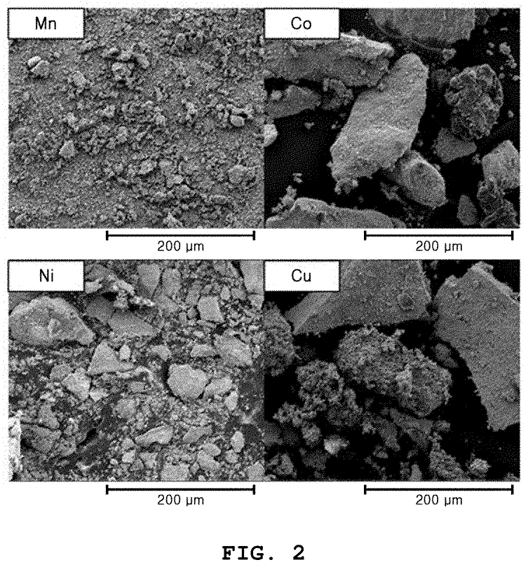

FIG. 2 includes SEM images of SO₄²⁻-functionalized transition metal oxide grains according to Embodiments 6 to 9 of the present invention.

Referring to FIGS. 1 and 2, it is shown that transition metal oxide grains have a small diameter and have a rough surface with pores or protrusions. In this case, a surface area thereof is increased and thus a catalytic decomposition rate of H₂O₂ is increased. As such, a rate at which .OH species are formed and a rate at which SO₄²⁻ functional groups on the catalyst surface are converted into SO_{4.}⁻-surface species by the .OH species may be increased.

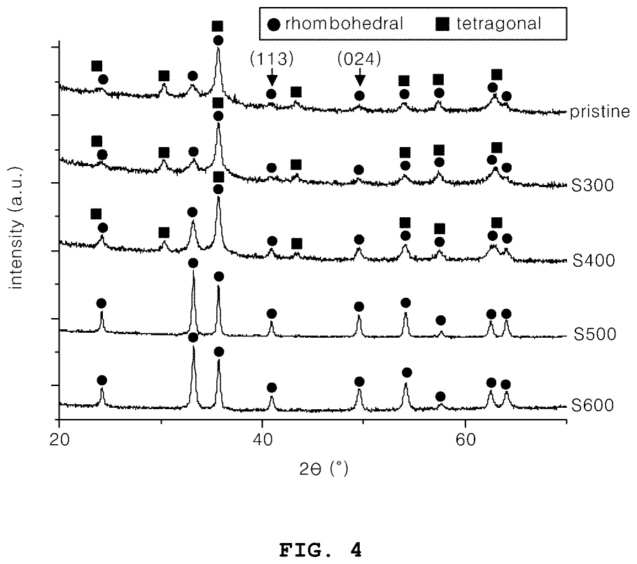

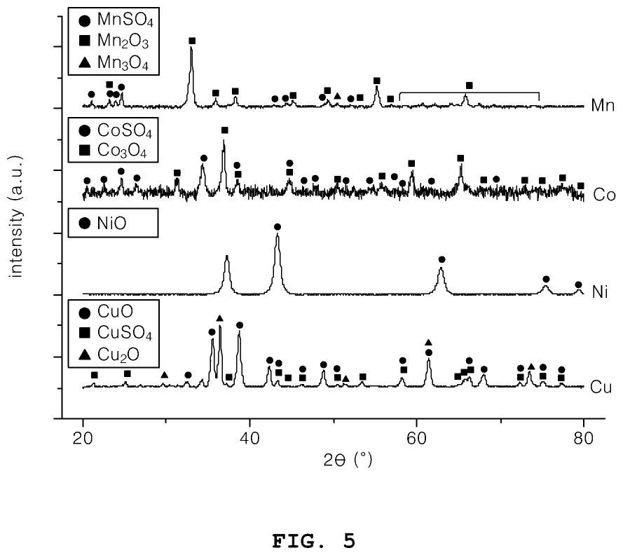

FIG. 4 is a graph showing X-ray diffraction (XRD) patterns of iron oxide grains and SO₄²⁻-functionalized iron oxide grains according to Embodiments 1 to 5 of the present invention, and FIG. 5 is a graph showing XRD patterns of SO₄²⁻-functionalized manganese, cobalt, nickel, and copper oxide grains according to Embodiments 6 to 9 of the present invention.

Referring to FIG. 4, it is shown that the pristine catalyst of Embodiment 1 and the catalysts S300 and S400 of Embodiments 2 and 3 have a combination of a stable rhombohedral Fe₂O₃ phase and a tetragonal Fe₂O₃ phase, and the catalysts S500 and S600 of Embodiments 4 and 5 have a stable rhombohedral Fe₂O₃ phase. This means that functionalization of the Fe₂O₃ surface by SO₄²⁻ does not create a new bulk phase such as Fe₂(SO₄) and thus does not exert a greatly influence on a crystal structure of the catalyst.

Referring to FIG. 5, it is shown that the catalysts of Embodiments 6 to 9 have metal sulfides MnSO₄, CoSO₄, and CuSO₄ because oxides Mn₂O₃, Mn₃O₄, Co₃O₄, NiO, CuO, and Cu₂O of the used metal precursors or metal oxides are changed by SO₆₅ ²⁻. All catalysts show a porous shape as verified by Brunauer-Emmett-Teller (BET) surface area values (10 m² g_{CAT}⁻¹ to 130 m² g_{CAT}⁻¹) of the catalysts.

To observe property variations of the transition metal oxide catalysts based on sulfation temperature variations (from 300° C. to 600° C.), the catalysts of Embodiments 1 to 5 were analyzed in various manners.

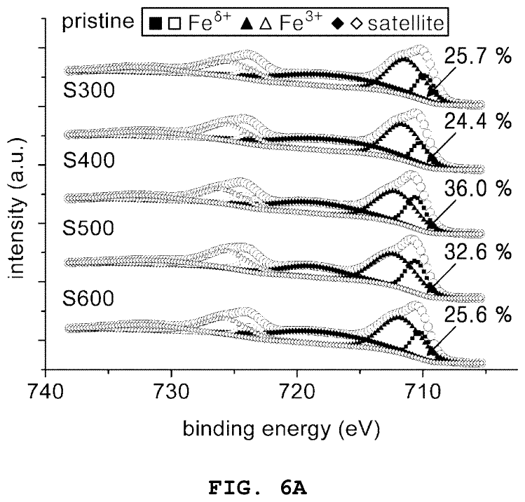

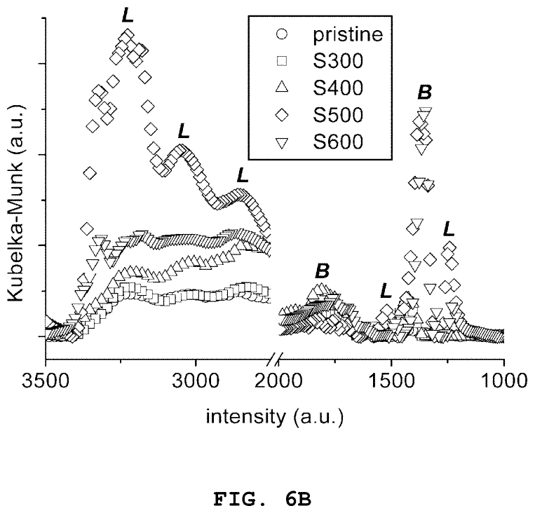

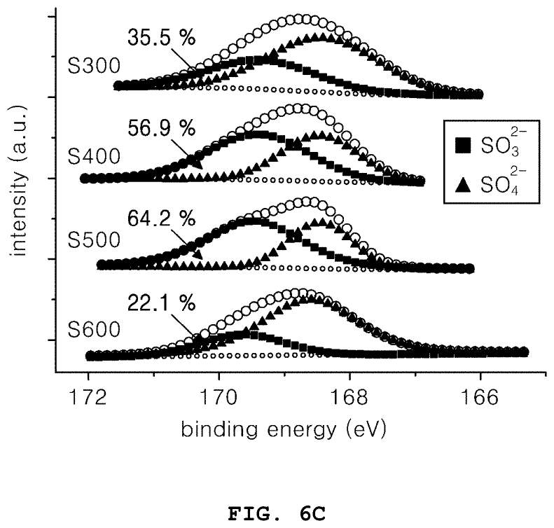

To analyze Fe surface species of the catalysts of Embodiments 1 to 5, X-ray photoelectroscopy (XP) was used and results thereof are shown in FIG. 6A. It is shown that all catalysts have Fe^{δ+} and Fe³⁺ surface species and the catalysts S400 and S500 of Embodiments 3 and 4 have larger quantities of Fe^{δ+} surface species.

To quantitatively analyze CO-accessible Fe^{δ+} surface species (N_{CO}) having Lewis acid properties L, the catalysts of Embodiments 1 to 5 were analyzed using CO-pulse chemisorption.

Like the XP result, the catalysts S400 and S500 of Embodiments 3 and 4 provide larger quantities of Nco values compared to the other catalysts (catalysts S400 and S500 ≥2.6 μmolco g_{CAT}⁻¹; other catalysts ≤˜1.7 μmolco g_{CAT}⁻¹).

This means that the catalysts S400 and S500 of Embodiments 3 and 4 may increase the efficiency of catalytic decomposition of H₂O₂ and thus increase .OH productivity compared to the other catalysts.

To additionally analyze Fe surface species of the catalysts of Embodiments 1 to 5, diffuse reflectance infrared Fourier transform (DRIFT) spectroscopy was used and results thereof after the surfaces of the catalysts are saturated with NH₃ at 50° C. are shown in FIG. 6B.

Differently from the results of FIG. 6A, it is shown that the catalyst S500 of Embodiment 4 has the largest widths under peaks indicating NH₃-accessible Fe^{δ+} surface species having Lewis acid properties L, and the catalyst S400 of Embodiment 3 has an intermediate value. That is, the above analysis results show that the surface of the catalyst S500 of Embodiment 4 includes the largest quantity of Fe^{δ+} surface species. This means that the catalyst S500 may enable the most efficient catalytic decomposition of H₂O₂ and achieve the highest productivity of .OH compared to the other catalysts.

To analyze bulk sulfur contents of the catalysts of Embodiments 1 to 5, X-ray fluorescence (XRF) was used. Analysis results show that, compared to the other catalysts, the catalyst S500 includes the highest content of S per unit area (catalyst S500: ˜6.1 μmols m⁻²; other catalysts ≤˜5.3 μmols m⁻²).

To analyze S surface species the catalysts of Embodiments 1 to 5, XP was used and results thereof are shown in FIG. 6C. It is shown that all catalysts have SO₃²⁻ and SO₄²⁻ surface species and the catalyst S500 of Embodiment 4 has the largest quantity of SO₄²⁻ surface species. That is, this means that the largest quantity of SO₄²⁻ surface species in the catalyst S500 of Embodiment 4 compared to the other catalysts may be highly probable to be transited to the largest quantity of SO_{4.}⁻-surface species due to radical conversion by the most sufficient quantity of .OH. In other words, this means that the catalyst S500 of Embodiment 4 may achieve the highest non-biodegradable organic material decomposition efficiency.

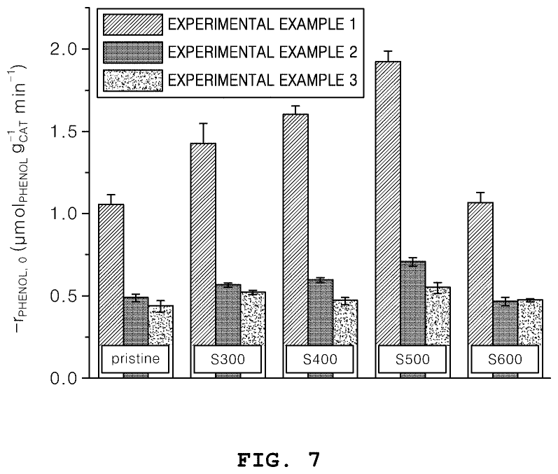

The performance of an electro-Fenton system using the catalysts of Embodiments 1 to 9 will now be described with reference to FIGS. 7 to 10.

### Experimental Example 1: Phenol Decomposition Test

An electro-Fenton test was performed using the catalysts of Embodiments 1 to 5, a graphite electrode, phenol (C₆H₅OH) as an organic material, and an aqueous electrolyte solution of Na₂SO₄. When 0.2 g of each catalyst was coated on one surface of the electrode, polyvinylidene fluoride (PVDF) was used as a binder. 100 mL of an aqueous solution in which 0.1 mmol of phenol (N_{PHENOL,0}) and 0.2 mol of Na₂SO₄ were dissolved was used as a reaction solution. The electro-Fenton test was performed at a pH of 5 to 7 at a power of 0.04 W.

A slope of a pseudo-1^{st}-order kinetic fitting curve (-In(C_{PHENOL}/C_{PHENOL,0}) VS. time) obtained based on a conversion rate of phenol in the test equals a phenol decomposition rate constant k_{APP} (min⁻¹).

An initial phenol decomposition rate -r_{PHENOL,0} (μmol_{PHENOL} g_{CAT}⁻¹ min⁻¹) is calculated by obtaining a product of k_{APP} of each catalyst and N_{PHENOL,0} (0.1 mmol) and dividing the product by the used quantity (0.2 g) of the catalyst, and is shown in FIG. 7.

As predicted above in relation to the property analysis results of the catalysts of Embodiments 1 to 5, the sulfated catalysts of Embodiments 2 to 5 have excellent properties compared to the non-sulfated catalyst of Embodiment 1. In particular, the catalyst S500 of Embodiment 4 has a higher -r_{PHENOL,0} value compared to the non-SO₄²⁻-functionalized pristine catalyst of Embodiment 1 and the other SO₄²⁻-functionalized catalysts S300, S400, and S600. This result means that a SO₄²⁻-functionalized transition metal oxide catalyst may achieve improved performance of non-biodegradable organic material decomposition compared to a non-SO₄²⁻-functionalized transition metal oxide catalyst.

### Experimental Example 2: Phenol Decomposition Test Using Radical Quencher

Reaction processes were performed using the catalysts of Embodiments 1 to 5under the same conditions as Experimental Example 1 after adding an excessive quantity of isopropyl alcohol (IPA) capable of quenching .OH and SO_{4.}⁻-species formed during reaction, and results thereof are shown in FIG. 7.

The quantity of IPA added for each reaction process is calculated by adding two times the quantity of H₂O₂ formed by applying power, to a bulk S content in each of the catalysts of Embodiments 1 to 5. It is shown that -r_{PHENOL,0} values of all catalysts in Experimental Example 2 performed after adding the IPA are greatly reduced compared to Experimental Example 1. This means that phenol is decomposed by .OH or SO_{4.}⁻-formed during electro-Fenton reaction.

### Experimental Example 3: Phenol Adsorption Test Without Applying Power

To clarify the reason why the -r_{PHENOL,0} values of Experimental Example 2 performed after adding an excessive quantity of IPA are not 0, Experimental Example 3 capable of clarifying the quantity of phenol adsorbed onto the surface of each of the catalysts of Embodiments 1 to 5 was performed.

Experimental Example 3 was performed under the same conditions as Experimental Example 1 except that power is not applied, and results thereof are shown in FIG. 7.

It is shown that -r_{PHENOL,0} values of the pristine catalyst of Embodiment 1 and the catalysts S300 and S600 of Embodiments 2 and 5 in Experimental Example 3 are almost the same as those in Experimental Example 2. This means that the pristine catalyst of Embodiment 1 and the catalysts S300 and S600 of Embodiments 2 and 5 may only adsorb and not decompose phenol when IPA serving as a radical quencher is present.

It is observed that -r_{PHENOL,0} values of the catalysts S400 and S500 of Embodiments 4 and 5 in Experimental Example 2 performed by adding the radical quencher are greater than those in Experimental Example 3 related to an adsorption quantity of phenol. It is regarded that this result is because, although an excessive quantity of IPA is present, the catalysts S400 and S500 include larger quantities of Fe^{δ+} and SO₄²⁻-functional groups compared to the other catalysts and thus .OH and SO_{4.}⁻ are uninterruptedly formed under electro-Fenton conditions capable of continuous production of H₂O₂. However, the test results of the catalysts S400 and S500 do not rebut a contention that decomposition of phenol on Fe₂O₃ catalysts including SO₄²⁻-functional groups is performed by .OH or SO_{4.}-.

### Experimental Example 4: Phenol Decomposition Based On Heterogeneous Catalysis

To verify that decomposition of phenol on Fe₂O₃ catalysts including SO₄²⁻ functional groups is performed by .OH or SO_{4.}⁻, Experimental Example 4 was performed using the catalysts of Embodiments 1 to 5 under the same conditions as Experimental Example 1.

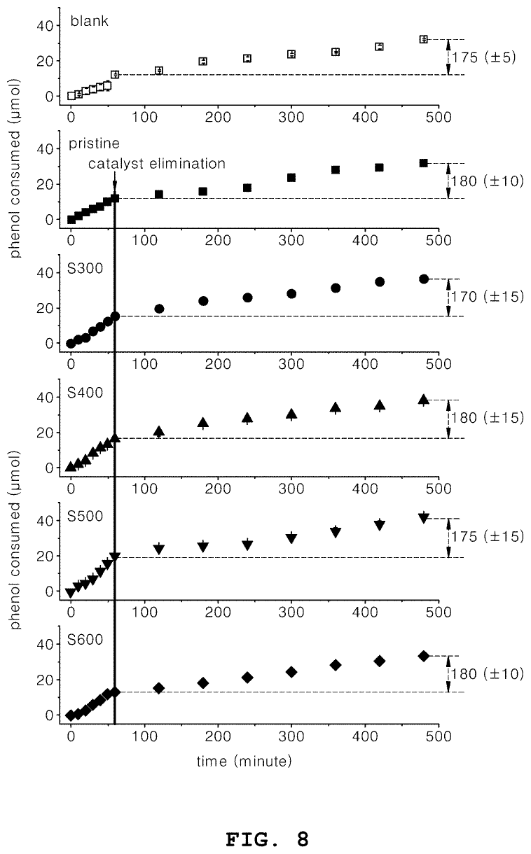

In this case, a test was performed for 1 hour in the same manner as Experimental Example 1 and then was continued after replacing the cathodes of Embodiments 1 to 5 with cathodes having no catalysts and filtering the reaction aqueous solutions. Decomposition quantities of phenol based on time were monitored and are shown in FIG. 8.

FIG. 8 is a graph showing decomposition quantities of phenol based on time, according to embodiments of the present invention. Referring to FIG. 8, decomposition quantities of phenol on the cathodes of Embodiments 1 to 5 after 1 hour are observed as 180±10 μM, 170±5 μM, 180±15 μM, 175±15 μM, and 180±10 μM, respectively. Specifically, these values are similar to 175±5 μM corresponding to a decomposition quantity of phenol observed in a reaction process performed without coating a transition metal oxide catalyst on a cathode. This means that main reaction for .OH or SO_{4.}⁻formation occurs based on heterogeneous catalysis by Fe^{δ+} or SO_{4.}⁻ included in transition metal oxide coated on and not leached from an electrode.

### Experimental Example 5: Catalyst Durability Test and Verification of Phenol Decomposition by SO_{4.}⁻

To verify durability of each catalyst and to clarify a main phenol decomposition path -specifically, 1) phenol decomposition due to .OH formation by Fe^{δ+} on the catalyst surface or 2) phenol decomposition by SO_{4.}-surface species due to activation of SO₄²⁻ functional groups on the catalyst surface- on Fe₂O₃ catalysts including SO₄²-functional groups, Experimental Example 5 was performed using the catalysts S400 and S500 of Embodiments 3 and 4, which have the highest performances of phenol decomposition in Experimental Example 1, under the same conditions as Experimental Example 1.

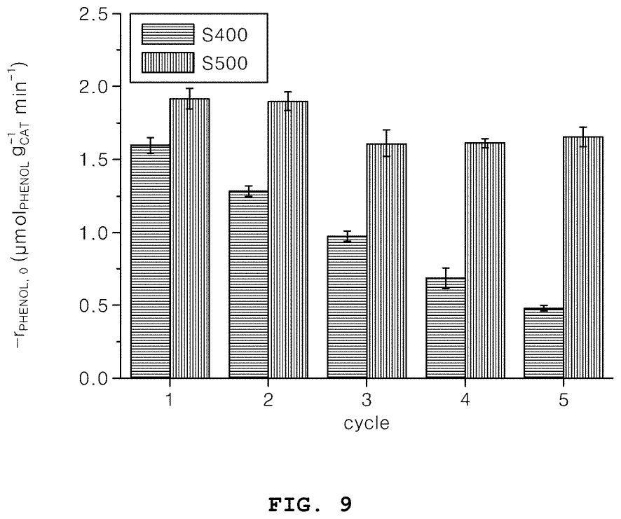

The catalysts after each reaction cycle are washed/dried/accumulated and are used for a subsequent reaction cycle. Results of Experimental Example 5 are shown in FIG. 9. It is shown that a -r_{PHENOL,0} value of the catalyst S400 is continuously reduced from ˜1.6 μmol_{PHENOL} g_{CAT}⁻¹ min⁻¹ to 0.4 μmol_{PHENOL} g_{CAT}⁻¹ min⁻¹ based on repetition of the reaction cycle.

In contrast, a -r_{PHENOL,0} value of the catalyst S500 is ˜1.9 μmol_{PHENOL} g_{CAT}⁻¹ min⁻¹ in 1^{st} and 2^{nd} cycles and is maintained as ˜1.6 μmol_{PHENOL} g_{CAT}⁻¹ min⁻¹ after a 3^{rd} cycle.

Like the results of Experimental Example 1, the results of Experimental Example 5 mean that selection of an appropriate condition (specifically, a temperature in the present invention) for surface sulfation of a transition metal oxide catalyst is critical for continuous improvement in the performance of non-biodegradable organic material decomposition.

At the same time, the quantity of CO-accessible Fe^{δ+} (N_{CO}) on the surface of the catalyst S500 after each cycle was quantitatively analyzed using CO-pulse chemisorption. Unlike the trend of the -r_{PHENOL,0} value of the catalyst S500 based on repetition of the reaction cycle, the N_{CO} value is continuously reduced based on repetition of the reaction cycle (before 1^{st} cycle: ˜2.6 μmol_{CO} g_{CAT}⁻¹→before 4^{th} cycle: ˜0.2 μmol_{CO} g_{CAT}⁻¹). This means that a main phenol decomposition path of Fe₂O₃ catalysts including SO₄²-functional groups does not correspond to ‘phenol decomposition based on .OH formation by Fe^{δ+} on the catalyst surface’ but corresponds to ‘phenol decomposition based on SO_{4.}-surface species on the catalyst surface’.

### Experimental Example 6: Verification of Phenol Decomposition Adaptability of SO₄²-Functionalized Transition Metal Oxides

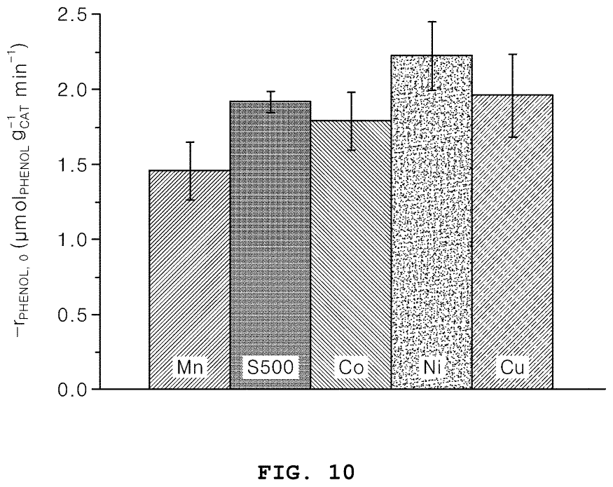

To verify non-biodegradable organic material decomposition adaptability of transition metal oxide catalysts including SO₄²-functional groups, Experimental Example 6 was performed using the Mn, Co, Ni, and Cu catalysts of Embodiments 6 to 9 under the same conditions as Experimental Example 1, and results thereof are shown in FIG. 10 together with the result of the catalyst S500 of Embodiment 4.

It is shown that -r_{PHENOL,0} values of the catalysts of Embodiments 6 to 9 (˜1.5 μmol_{PHENOL} g_{CAT}⁻¹ min⁻¹ to ˜2.3 μmol_{PHENOL} g_{CAT}⁻¹ min⁻¹) are similar to a -r_{PHENOL 0} value of the catalyst of Embodiment 4 (˜1.8 μmol_{PHENOL} g_{CAT}⁻¹ min⁻¹). This means that 1) the catalyst synthesis method and 2) the phenol decomposition method using SO_{4.}⁻ on the catalyst surface, which are proposed by the present invention, may use a variety of metal oxide catalysts.

Therefore, a catalyst for an electro-Fenton system, according to an embodiment of the present invention, may decompose non-biodegradable organic materials based on heterogeneous catalysis by coating SO₄²⁻-functionalized transition metal oxide catalysts on a cathode and distributing SO_{4.}⁻-functional groups formed as a result of radical conversion from .OH, on the surface of the transition metal oxide catalysts.

As such, the efficiency of non-biodegradable organic material decomposition may be increased, and leaching of metal species M^{δ+} having an oxidation number equal to or less than 2, or SO₄²⁻-functional groups from the catalyst surface during reaction may be reduced. Therefore, the performance and a lifespan of an electro-Fenton system for decomposing an organic material by using the catalyst may be increased.

As described above, according to an embodiment of the present invention, a non-biodegradable organic material may be decomposed based on heterogeneous catalysis by coating SO₄²⁻-functionalized transition metal oxide catalysts on an electrode.

Furthermore, according to the present invention, a new radical formation path by which continuous .OH formation is induced and formed .OH changes SO₄²⁻ species on the surface of a metal oxide catalyst, into SO_{4.}⁻-species through radical interconversion may be provided.

In addition, according to the present invention, leaching of grains during non-biodegradable organic material decomposition may be reduced using the catalyst, a non-biodegradable organic material decomposition rate may be maintained during multiple uses of the catalyst, and thus the performance and a lifespan of a reaction system may be increased.

However, the scope of the present invention is not limited to the above-described effects.

While the present invention has been particularly shown and described with reference to embodiments thereof, it will be understood by one of ordinary skill in the art that various changes in form and details may be made therein without departing from the scope of the present invention as defined by the following claims.

What is claimed is:

1. A catalyst for an electro-Fenton system, the catalyst comprising one or more species of SO₄²⁻-functionalized transition metal oxide grains.

2. The catalyst of claim 1, wherein the transition metal oxide grains have a porous structure.

3. The catalyst of claim 1, wherein the transition metal oxide grains have a diameter of 0.1 nm to 500 μm.

4. The catalyst of claim 1, wherein a transition metal of the transition metal oxide grains comprises at least one or a combination of two or more selected from the group consisting of scandium (Sc), titanium (Ti), vanadium (V), chromium (Cr), manganese (Mn), iron (Fe), zinc (Zn), copper (Cu), nickel (Ni), cobalt (Co), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), and gold (Au).

5. The catalyst of claim 1, wherein .OH species are formed due to heterogeneous catalysis of the transition metal oxide grains.

6. The catalyst of claim 5, wherein the .OH species convert SO₄²⁻ species functionalized on surfaces of the transition metal oxide grains, into SO_{4.}⁻ species, and wherein a non-biodegradable organic material is decomposed by the SO_{4.-}species.

7. An electrode for an electro-Fenton system, the electrode comprising the catalyst of claim 1.

8. The electrode of claim 7, further comprising:
a conductive substrate;
a catalyst layer coated on at least one surface of the conductive substrate and comprising the catalyst; and
a binder layer provided between the conductive substrate and the catalyst layer.

9. The electrode of claim 8, wherein the catalyst layer comprises a carrier supporting the catalyst.

10. The electrode of claim 9, wherein the carrier comprises carbon (C), Al₂O₃, MgO, ZrO₂, CeO₂, TiO₂, or SiO₂.

11. The electrode of claim 10, wherein the catalyst is comprised by 0.01 weight part to 50 weight parts based on 100 weight parts of the carrier.

12. The electrode of claim 9, wherein a binder of the binder layer comprises insoluble polymer.

13. An electro-Fenton system comprising:
the catalyst of claim 1;
an electrode comprising the catalyst; and
an aqueous electrolyte solution.

14. The electro-Fenton system of claim 13, wherein the aqueous electrolyte solution has a pH ranging from 5 to 10.
